(19) United States
(12) Patent Application Publication
(10) Pub. No.: US 2025/0321721 A1
(43) Pub. Date: Oct. 16, 2025

(54) CONTEXT-BASED SOFTWARE ENGINEERING USING ARTIFICIAL INTELLIGENCE TECHNIQUES

(71) Applicant: Dell Products L.P., Round Rock, TX (US)

(72) Inventors: Dhilip S. Kumar, Bangalore (IN); Arun Prasaad Sethuraman, Bangalore (IN)

(21) Appl. No.: 18/634,212

(22) Filed: Apr. 12, 2024

(51) Int. Cl. G06F 8/35

(52) U.S. Cl. CPC G06F 8/35

(57) ABSTRACT

Methods, apparatus, and processor-readable storage media for context-based software engineering using artificial intelligence techniques are provided herein. An example computer-implemented method includes obtaining input data associated with at least one software program; predicting one or more outputs which can be generated by the at least one software program, in response to at least a portion of the input data, by processing the input data using one or more artificial intelligence techniques; generating one or more items of supporting information attributed to at least a portion of the one or more predicted outputs; and automatically reverse engineering at least a portion of the at least one software program using at least one of the one or more predicted outputs and the one or more items of supporting information.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Conventional software reverse engineering techniques, used in contexts such as software maintenance, software repair, etc., commonly include learning about a software product by dissecting its source code. However, such conventional techniques can often be time-consuming, resource-intensive, and platform and/or programming language dependent, which is particularly problematic in circumstances wherein a skilled engineer or other practitioner is not available to carry out the source code dissection.

### SUMMARY

Illustrative embodiments of the disclosure provide techniques for context-based software engineering using artificial intelligence techniques.

An exemplary computer-implemented method includes obtaining input data associated with at least one software program, and predicting one or more outputs which can be generated by the at least one software program, in response to at least a portion of the input data, by processing the input data using one or more artificial intelligence techniques. The method also includes generating one or more items of supporting information attributed to at least a portion of the one or more predicted outputs, and automatically reverse engineering at least a portion of the at least one software program using at least one of the one or more predicted outputs and the one or more items of supporting information.

Illustrative embodiments can provide significant advantages relative to conventional software reverse engineering techniques. For example, problems associated with time-consuming, resource-intensive, and platform and/or programming language dependent techniques are overcome in one or more embodiments through automatically reverse engineering at least a portion of a given software program, without needing to examine the source code of the given software program, using one or more artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for context-based software engineering using artificial intelligence techniques in an illustrative embodiment.

FIG. 2 shows an example workflow involving a software program to be reverse engineered in an illustrative embodiment.

FIG. 3 shows an example table containing information captured across multiple entities in connection with a software program to be reverse engineered in an illustrative embodiment.

FIG. 4 shows an example table of invoked software program monitoring data in an illustrative embodiment.

FIG. 5 shows an example table of software program monitoring data in an illustrative embodiment.

FIG. 6 shows an example table of database operations data associated with software program monitoring data in an illustrative embodiment.

FIG. 7 shows an example table of database operations data associated with software program monitoring data in an illustrative embodiment.

FIG. 8 shows an example neural network architecture in an illustrative embodiment.

FIG. 9 shows an example workflow involving a multimodal artificial intelligence-based prediction engine in an illustrative embodiment.

FIG. 10 shows example pseudocode for determining system behavior associated with a given item of software in an illustrative embodiment.

FIG. 11 shows example pseudocode for implementing at least a portion of a multimodal artificial intelligence-based prediction engine in an illustrative embodiment.

FIG. 12 shows example pseudocode for generating at least a portion of a software reverse engineering output in an illustrative embodiment.

FIG. 13 is a flow diagram of a process for context-based software engineering using artificial intelligence techniques in an illustrative embodiment.

FIGS. 14 and 15 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

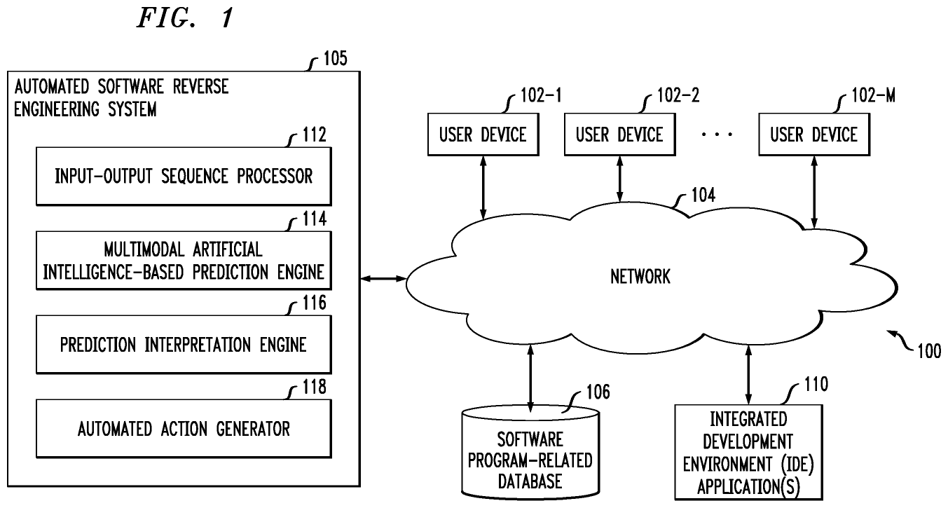

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated software reverse engineering system 105 and one or more integrated development environment (IDE) applications 110.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated software reverse engineering system 105 can have an associated software program-related database 106 configured to store data pertaining to software program inputs, software program outputs, database operations, etc.

The software program-related database 106 in the present embodiment is implemented using one or more storage systems associated with the automated software reverse engineering system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated software reverse engineering system 105 are one or more input-output devices, which illustratively comprise keyboards, displays or other types of input-output devices in any combination. Such input-output devices can be used, for example, to support one or more user interfaces to the automated software reverse engineering system 105, as well as to support communication between the automated software reverse engineering system 105 and other related systems and devices not explicitly shown.

Additionally, the automated software reverse engineering system 105 in the FIG. 1 embodiment is assumed to be implemented using at least one processing device. Each such processing device generally comprises at least one processor and an associated memory, and implements one or more functional modules for controlling certain features of the automated software reverse engineering system 105.

More particularly, the automated software reverse engineering system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated software reverse engineering system 105 to communicate over the network 104 with the user devices 102, and illustratively comprises one or more conventional transceivers.

The automated software reverse engineering system 105 further comprises input-output sequence processor 112, multimodal artificial intelligence-based prediction engine 114, prediction interpretation engine 116, and automated action generator 118.

It is to be appreciated that this particular arrangement of elements 112, 114, 116 and 118 illustrated in the automated software reverse engineering system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for context-based software engineering using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated software reverse engineering system 105, software program-related database 106, and IDE application(s) 110 can be on and/or part of the same processing platform.

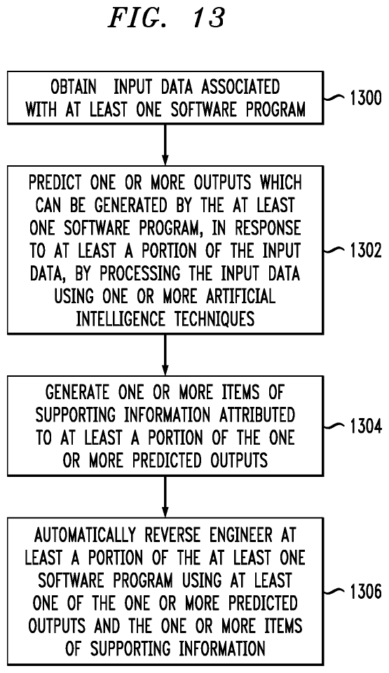

An exemplary process utilizing elements 112, 114, 116 and 118 of an example automated software reverse engineering system 105 in computer network 100 will be described in more detail with reference to the flow diagram of FIG. 13.

Accordingly, at least one embodiment includes context-based software engineering using artificial intelligence techniques. As further detailed herein, such an embodiment is platform agnostic and programming language agnostic, reduces and/or minimizes human interaction, and allows users to access software-related information directly without having to examine the corresponding source code. Such an embodiment includes automatically learning and/or deriving, using artificial intelligence techniques, one or more insights on the operating process of a given software program (e.g., a software application) from the context of one or more functionalities without needing to dissect the source code of the software program. For example, at least one embodiment can include learning and/or deriving one or more insights on the operating process of a given software program by processing and/or understanding one or more outputs generated by the given software program for at least one given input, and/or by processing and/or understanding one or more data transformations occurring in conjunction with such output generation.

One or more embodiments include identifying transactional information in connection with existing application performance and process monitoring tools to facilitate a reverse engineering process. At least one sequence of steps, as well as input(s) and output(s) for each such step, can be monitored and/or collected over a given time period, and an artificial intelligence-based reverse engineering prediction engine can process at least a portion of such data to learn one or more insights associated with the corresponding software program by determining relationships across such steps, input(s), and output(s).

As detailed herein, in one or more embodiments, an automated software reverse engineering engine can include elements including an input-output sequence processor, a multimodal artificial intelligence-based prediction engine, and a prediction interpretation engine. In such an embodiment, the input-output sequence processor collects and/or obtains information that is contained in application processing monitoring logs, which can then be used to determine the order of one or more stages within the application flows (e.g., taking input, connecting to an external database, application programming interface (API) calls, etc.) as well as input(s) and output(s) corresponding thereto. Such application processing logs can be processed in the form of at least one time series of logs, and the input-output sequence processor can analyze such time series data to sequence application steps as well as input(s) and output(s) corresponding thereto.

As also noted above, one or more embodiments include using a multimodal artificial intelligence-based prediction engine, which can implement supervised and/or unsupervised techniques that employ decision trees and/or one or more neural networks to detect patterns and structures based at least in part on the complexity of the application stages, input(s), and output(s) and/or based at least in part on how the software application in question operates. Such an embodiment includes carrying out such actions to attempt to determine one or more functionalities and/or capabilities built into the code.

Further, a prediction interpretation engine can be implemented to interpret one or more predictions generated by the multimodal artificial intelligence-based prediction engine. More particularly, the prediction interpretation engine can provide model-agnostic explanations and/or descriptions of the software in question based at least in part on the one or more predictions generated by the multimodal artificial intelligence-based prediction engine. For example, in at least one embodiment, the prediction interpretation engine can perturb one or more data points and generate corresponding synthetic data which can be utilized as part of a training set for at least one glass box model. In such an embodiment, the glass box model is a transparent model wherein application functionality is seen as interpreted by the techniques described herein. In at least one embodiment, context information related to the given software program and/or information pertaining to the software program's workflow(s) can be processed by the prediction interpretation engine to create one or more explanations of one or more portions of the software program.

As further detailed below and herein, one or more embodiments include using at least one available data monitoring system to obtain traces of a given software program and mapping, based at least in part on such traces, the input(s) and the output(s) associated with the given software program. Such mapped data can then be fed to and/or processed by at least one model generator, along with one or more items of context-related data associated with the given software program. More particularly, such an embodiment can include mapping variables and/or attributes in the input(s) and output(s) to context information. For example, a variable x in the code could represent parts, orders, user information, etc.

The at least one model generator can build a model and use explainable artificial intelligence to read out the model in at least one human-understandable format and identify the business logic underneath the model. By way of example and/or illustration, a given application (which is a black box) generates traces, logs, etc. A first model can be implemented to process such data, as well as context information, as input to create a second model, which mimics the given application. Additionally, explainable artificial intelligence, which understands what the second model has learned to that point, can be used to determine and/or provide one or more functionalities behind the given application. Accordingly, in such an example embodiment, each application being analyzed will have its own respective second model.

Accordingly, and as detailed herein, one or more embodiments include performing programming language agnostic reverse engineering of a given software program without opening the source code of the software program by analyzing the input(s) and the output(s) of the software program, and tracing the input(s) and the output(s) of one or more software program calls and/or one or more database calls with which the software program is interacting.

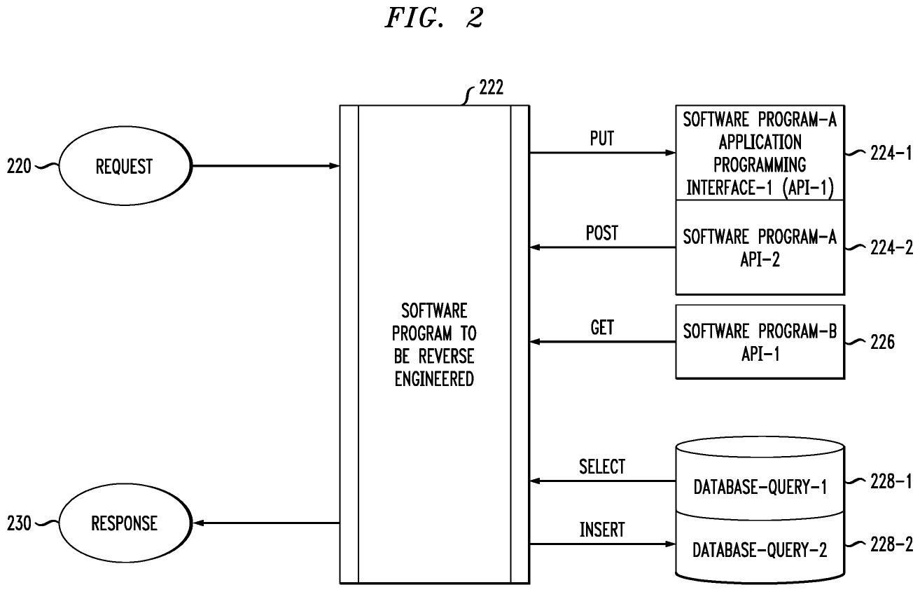

FIG. 2 shows an example workflow involving a software program to be reverse engineered in an illustrative embodiment. By way of illustration, FIG. 2 depicts software program 222 receiving a request 220 (e.g., an input), and based at least in part thereon, performing operations (e.g., put, post, and get operations) in connection with software program-A API-1 224-1, software program-A API-2 224-2, and software program-B API 1 226. Additionally, FIG. 2 depicts software program 222 also performing select and insert operations in connection with database-query-1 228-1 and database-query-2 228-2. Based at least in part on the operations noted above, software program 222 generates and outputs a response 230 (e.g., an output) to request 220. Also, in at least one embodiment, the actions illustrated in the example workflow of FIG. 2 and detailed above can be associated with a given trace identifier (ID).

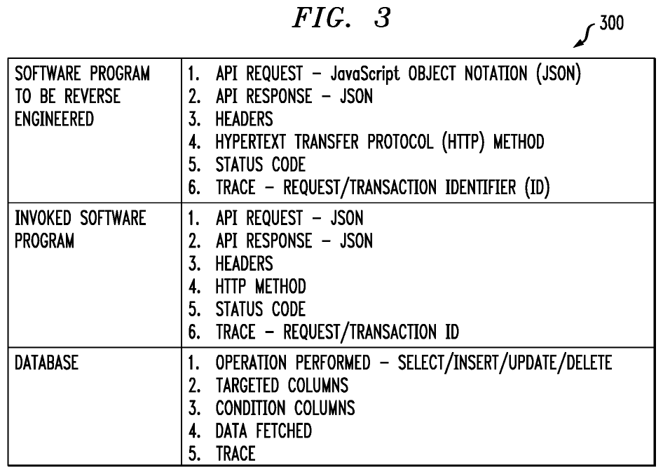

FIG. 3 shows an example table containing information captured across multiple entities in connection with a software program to be reverse engineered in an illustrative embodiment. By way of illustration, FIG. 3 depicts table 300, which contains information, captured through one or more monitoring applications, pertaining to the software program to be reverse engineered, including information associated with API requests, API responses, headers, hypertext transfer protocol (HTTP) method implementation(s), status code(s), and trace data (e.g., request and/or transaction IDs). Additionally, table 300 contains information pertaining to a software program invoked by the software program to be reverse engineered, wherein such information can similarly include API requests, API responses, headers, HTTP method implementation(s), status code(s), and trace data (e.g., request and/or transaction IDs). Further, table 300 contains information pertaining to operations carried out by the software program to be reverse engineered in connection with a give database, wherein such information can include identification information of the operation(s) performed, targeted columns in the database, condition columns in the database, data fetched, and trace data (e.g., trace IDs).

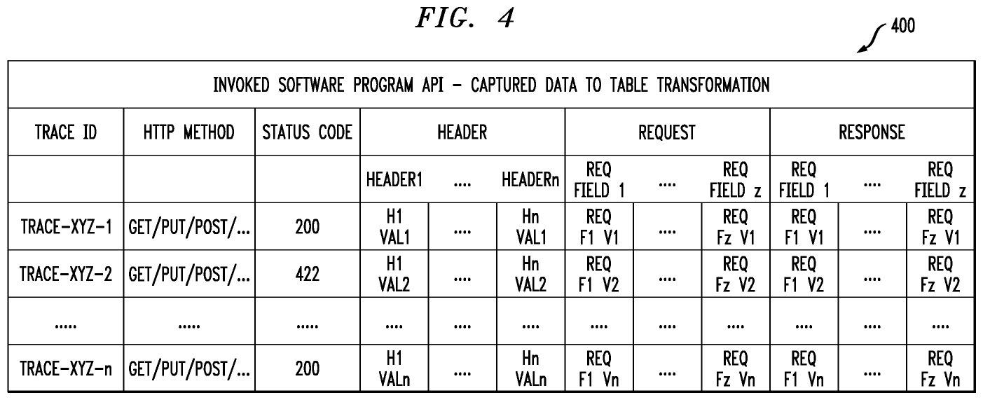

As described herein, and as further detailed in connection with FIG. 4 through FIG. 7, a trace ID connects a complete sequence of documented events to determine and/or comprehend what is occurring during at least one transaction involving a given software program.

FIG. 4 shows an example table of invoked software program monitoring data in an illustrative embodiment. By way of illustration, FIG. 4 depicts example table 400 which includes information from an invoked software program API (that is, a software program API invoked by a given software program to be reversed engineered), derived from application monitoring data. Such information is then extracted and/or organized into example table 400 under columns including trace ID, HTTP method, status code, header(s), request, and response. Also, in one or more embodiments, each of multiple software program APIs can have a table, similar to example table 400, associated therewith. Also, example table 400 can be a representation of information captured in transactions marked in connection with elements 224-1, 224-2 and 226 in FIG. 2.

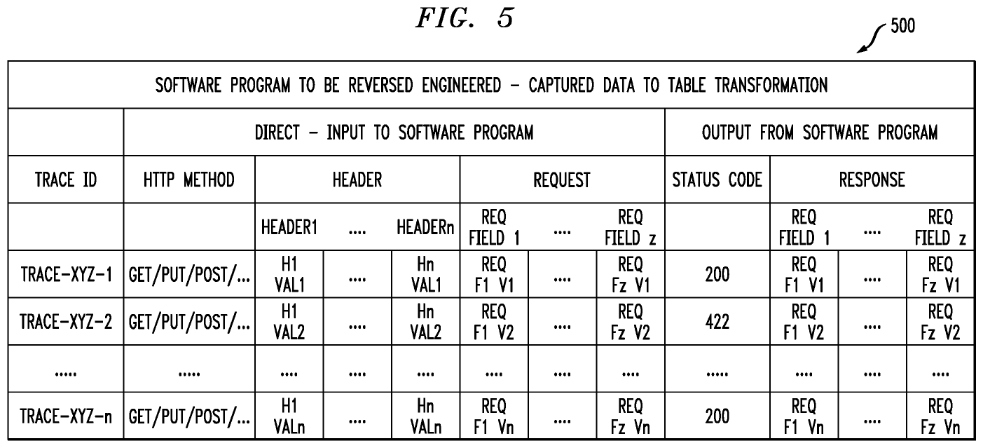

FIG. 5 shows an example table of software program monitoring data in an illustrative embodiment. By way of illustration, FIG. 5 depicts example table 500 which includes information from a software program API that is to be reversed engineered, derived from application monitoring data. Such information is then extracted and/or organized into example table 500 under columns categorized as trace ID, directed input to software program (e.g., HTTP method, header(s), and request) and output from software program (e.g., status code and response). Also, example table 500 can be a representation of information captured in transactions marked in connection with elements 220 and 230 in FIG. 2.

FIG. 6 shows an example table of database operations data associated with software program monitoring data in an illustrative embodiment. By way of illustration, FIG. 6 depicts example table 600 which includes database operations data derived from database operations carried out in connection with a software program that is to be reversed engineered. Such data is extracted and/or organized into example table 600 under columns categorized as trace ID, operation performed, condition columns of the database, and targeted columns of the database. Also, in one or more embodiments, each of multiple software program-database queries can have a table, similar to example table 600, associated therewith. Also, example table 600 can be a representation of information captured in transactions marked in connection with elements 228-1 and 228-2 in FIG. 2.

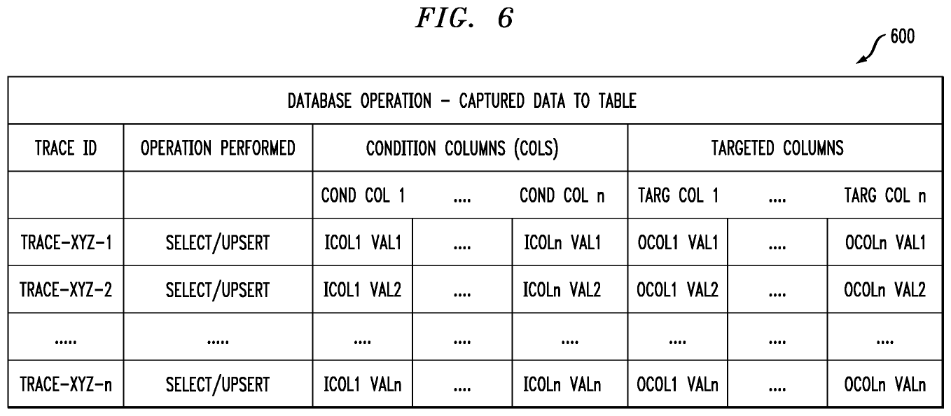

FIG. 7 shows an example table of database operations data associated with software program monitoring data in an illustrative embodiment. By way of illustration, FIG. 7 depicts example consolidated table 700 which includes columns categorized as trace ID, input columns (e.g., direct input column(s) for the software program to be reverse engineered, invoked software program-A API-1 column(s), invoked software program-A API-2 column(s), invoked software program-B API-1 column(s), query-1 column(s), and query-2 column(s)), and output columns (e.g., column(s) for output(s) from the software program to be reverse engineered). Also, in one or more embodiments, each column in example consolidated table 700 can be divided into one or more further columns from the respective software program and/or query table. Also, example consolidated table 700 can represent a consolidated view of example table 400, example table 500, and example table 600 illustrated in FIG. 4, FIG. 5, and FIG. 6, respectively.

In one or more embodiments, various software program-related data is collected, processed, and sequenced as input and output variables and/or parameters. Such input can include, for example, JavaScript object notation (JSON) values for the software program and related log information such as, e.g., software program details and corresponding input(s) and output(s), followed by database operations and one or more statements thereof. The output and/or prediction value can also be generated and/or returned in JSON values. In at least one embodiment, input data in the form of tables can be joined together based at least in part on trace IDs and all columns therein can be considered as input (e.g., with the exception of any software program “output from software program” columns. This can represent one example of data that can be collected whenever the software program is invoked.

Referring again to the multimodal artificial intelligence-based prediction engine implemented as part of one or more embodiments, such an engine plays a role in training the model for a specific software program (e.g., the model created to mimic the specific software application being reverse engineered). For example, one or more embodiments can include training and implementing a separate model for each software program to be reverse engineered. By instructing the multimodal artificial intelligence-based prediction engine to learn and/or comprehend a given software program, the multimodal artificial intelligence-based prediction engine can determine and/or generate a list of parameters that influence the outcome of the software program with precision, which will aid in providing an explanation during the process of reverse engineering.

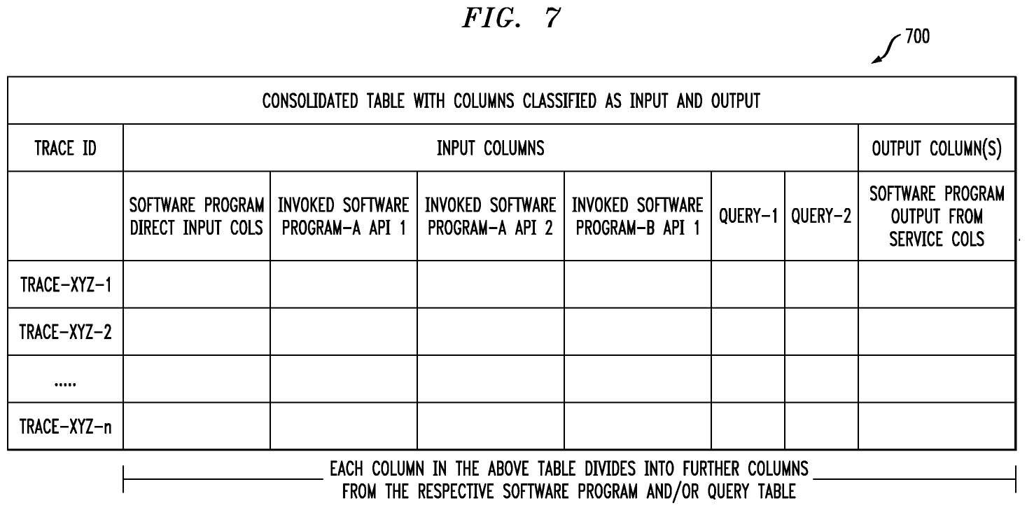

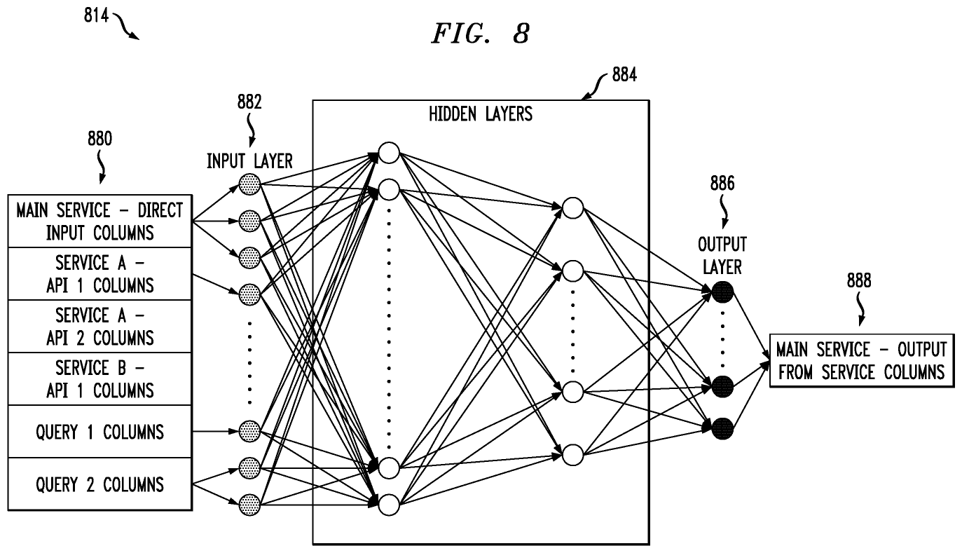

FIG. 8 shows an example neural network architecture in an illustrative embodiment. By way of illustration, FIG. 8 depicts neural network 814, which can represent, in one or more embodiments, at least a portion of a multimodal artificial intelligence-based prediction engine (e.g., element 114 in FIG. 1). In such an embodiment neural network 814 includes at least one multi-input multi-output (MIMO) neural network to predict software program behavior based on various features. A target variable and/or dependent variable of neural network 814 can be a software program behavioral attribute such as, e.g., service type, database call type, etc. Also, based at least in part on the target variable and/or dependent variable, neural network 814 predicts one or more outputs of the software program.

As noted above, in one or more embodiments, the neural network 814 includes at least one MIMO neural network which contains an input layer 882, one or more hidden layers 884 (e.g., two hidden layers), and an output layer 886. In such an embodiment, the input layer 882 can include a number of neurons that match the number of input and/or independent variables 880 (e.g., input data such as captured in one or more table columns such as illustrated in FIG. 4, FIG. 5, FIG. 6 and/or FIG. 7 (which represents a consolidation of the tables in FIG. 4, FIG. 5, and FIG. 6), including data including software program direct inputs, invoked software program API data, database query data, etc.). Also, the hidden layer(s) 884 can include two hidden layers, and the number of neurons on each layer depends upon the number of neurons in the input layer 882. Further, in such an embodiment, the two hidden layers converge to the output layer 886, wherein each neuron in the output layer represents a feature(s) of interest (e.g., one or more fields and/or parameters of interest in the output and/or response JSON, such as depicted in the right-most columns in example table 500 in FIG. 5) with respect to the given software program in question. As also illustrated in FIG. 8, output layer 886 generates at least one output 888 in the form of predicted software program behavior (associated, e.g., with corresponding table column data) based on various features of interest (represented by the neurons in the output layer 886).

In one or more embodiments, neural network 814 can be used in conjunction with deep learning important features techniques for computing importance scores based at least in part on explaining the difference of the generated output 888 from at least one reference output in terms of differences of the at least a portion of the input and/or independent variables 880 from corresponding reference inputs. By way of illustration, deep learning techniques can be represented via a neural network having more than one hidden layer, such as implemented in connection with one or more embodiments. Using such a difference value allows information to propagate even when the gradient is zero, which can be useful, e.g., in connection with a recurrent neural network, wherein a saturating activations function such as a sigmoid activation function and/or a tanh activation function can be used. Additionally, in such an embodiment, implementing deep learning important features techniques reduces and/or avoids placing potentially misleading importance on bias terms by allowing separate treatment of positive and negative contributions.

Additionally, in such an embodiment, weights and biases can be initialized with random values, and during training, input data can be fed through and/or processed by the neural network via forward propagation. The input data can then be multiplied with the weights and passed through at least one activation function (which can be determined based on the particular data itself). Using at least one loss function, the error between the output and the expected output can be calculated, and using backpropagation, one or more of the weights can be adjusted. At least one embodiment can include using gradient descent techniques for optimizing the weights during backpropagation. As part of such gradient descent techniques, such an embodiment can include updating the weights and biases in the opposite direction of the gradients to reduce the loss.

One or more embodiments can also include implementing a learning rate which is a hyperparameter that controls how much the weights and biases are updated during the learning phase. Such an embodiment can include repeating the process iteratively using the available training data until a satisfactory performance level in prediction versus actual output convergence is achieved.

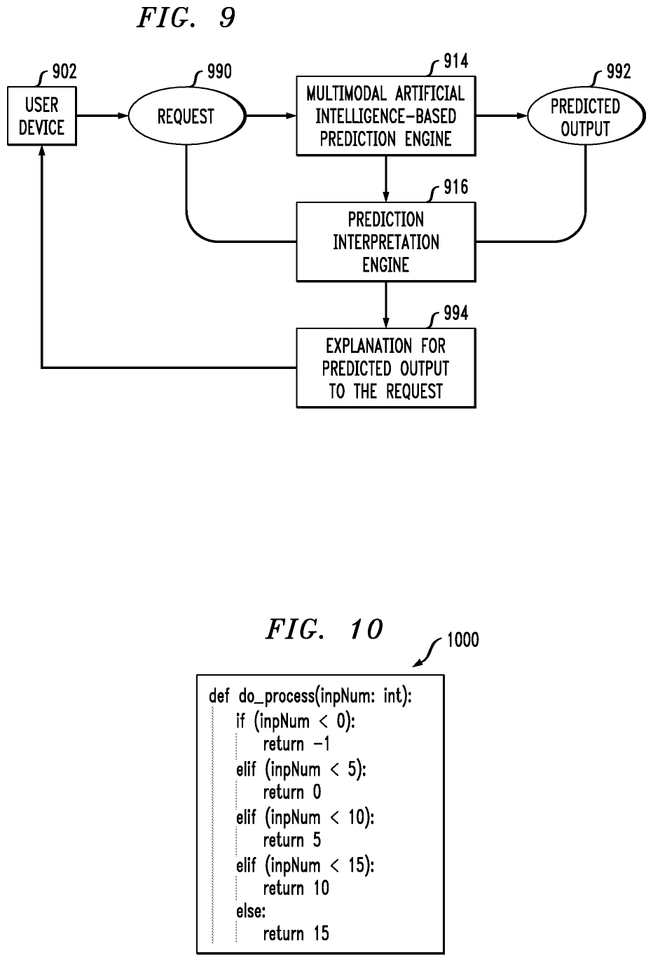

FIG. 9 shows an example workflow involving a multimodal artificial intelligence-based prediction engine in an illustrative embodiment. By way of illustration, FIG. 9 depicts user device 902 generating and outputting a request 990 to multimodal artificial intelligence-based prediction engine 914, which processes the request 990 and generates a predicted output 992 to the request 990. The predicted output 992, the request 990, and one or more inputs from multimodal artificial intelligence-based prediction engine 914 are provided to and/or processed by prediction interpretation engine 916, which generates an explanation 994 for the predicted output 992 to the request 990.

In one or more embodiments, multimodal artificial intelligence-based prediction engine 914 wraps around the model (e.g., the model which mimics the software program being reverse engineered) generated by the multimodal artificial intelligence-based prediction engine, and prediction interpretation engine 916 wraps around the explainable artificial intelligence which explains why the predicted output was given by the model (e.g., the model which mimics the software program being reverse engineered). Also, prediction interpretation engine 916 takes request 990, predicted output 992 and multimodal artificial intelligence-based prediction engine 914 all as inputs, and prediction interpretation engine 916 derives why the model (e.g., the model which mimics the software program being reverse engineered) arrived at the predicted output 992.

As also detailed herein, prediction interpretation engine 916 can utilize one or more different artificial intelligence techniques to generate such an explanation, wherein the particular artificial intelligence technique(s) used can be based at least in part on the model (e.g., the model which mimics the software program being reverse engineered) that is being generated.

One example is provided in example pseudocode 1100 in FIG. 11, wherein a functionality referred to as export_text is used, which encompasses explainable artificial intelligences that is efficient in reading decision tree models, which was also used in the noted example.

Accordingly, in one or more embodiments, because multimodal artificial intelligence-based prediction engine 914 is trained on data from and involving the particular software program being reversed engineered, prediction interpretation engine 916 can transitively explain why the response (e.g., the predicted output 992) was generated for the particular request 990.

As detailed herein, once at least one model of the given software program in question has been created, at least one embodiment can include using explainable artificial intelligence (e.g., prediction interpretation engine 916) to learn and/or understand why the software program is providing an output for a given input. Referring again to the prediction interpretation engine, which uses a trained model to comprehend the given input(s) that were transformed into one or more outputs and the intermediate steps related thereto, when the explanation of the output(s) by input(s) is understood, reverse engineering a service can be enabled. In such an embodiment, backpropagation can be utilized to travel from output to input in a single backward pass and identify the positive and negative input contributors for a given output.

By way merely of example, to comprehend the complexity of a given model, one or more embodiments can include sending a set off input and receiving a set off output using a neural network model. Such a set off input/output is illustrated, for example, in FIG. 8, and can include JSON input parameters, internal API call inputs/outputs, context information, and data from at least one database, versus output parameters in the software response.

In one or more embodiments, decomposing an output prediction of a neural network on a specific input can include backpropagating the contributions of all neurons in the neural network to every feature of the input. Such an embodiment can include leveraging one or more deep learning important features techniques that compare the activation of each neuron to its reference activation and assign one or more contribution scores according to the difference. By optionally giving separate consideration to positive and negative contributions, the one or more deep learning important features techniques can also reveal one or more dependencies, and one or more scores can be computed using an algorithm similar to backpropagation (e.g., gradient estimate, chain rule, etc.), obtained in a single backward pass after a prediction has been made.

For example, with respect to an input passed to the software program which is transformed into the software program's output, between the input and output, the one or more actions taken can be identified in reverse. Additionally, the one or more deep learning important features techniques can provide and/or determine the difference in an output from a reference output in terms of the difference in a corresponding input from a reference input.

By way merely of illustration, let t represent a target output neuron of interest, and let x1, x2, . . . , xn represent neurons in some intermediate layer and/or set of layers that are necessary and sufficient to compute t. Additionally, let t⁰ represent the reference activation of t, and let Δt represent the difference-from-reference. Accordingly, in such an example embodiment, Δt=t−t⁰, and assigning the contribution scores can be important for delta neurons such as, e.g., C_{ΔxiΔt} to Δxi, wherein C_{ΔxiΔt} represents the amount of difference-from-reference in t that is attributed to the difference-from-reference of xi. By way of further illustration, in one or more embodiments, when a neuron's transfer function is well-defined, the output is locally linear in its inputs.

Also, at least one embodiment can include defining the multiplier for an input neuron, x, with difference-from-reference, Δx, and a target neuron, t, with difference-from-reference, Δt, for which the contribution is to be computed. Given the multipliers for each neuron's immediate successors, backpropagation can compute the multipliers for any neuron to a given target neuron, analogous to how the chain rule for partial derivatives enables backpropagation to compute the gradient with respect to an output.

Additionally, in at least one embodiment, the multiplier mΔxΔt is the contribution of Δx to Δt divided by Δx. Also, the partial derivative

$$\frac{\partial t}{\partial x}$$

can represent the infinitesimal change in t caused by an infinitesimal change in x, divided by the infinitesimal change in x. As such, the multiplier is similar to a partial derivative, but over finite differences instead of infinitesimal ones.

By way of further illustration, assume an example including an input layer with the following neurons: x1, . . . , xn (e.g., input of the software program in question and other software programs and database parameters); a hidden layer with neurons y1, . . . , yn (e.g., computation(s) and/or step(s) that transform(s) x1, . . . , xn to y1, . . . , yn); and a target output neuron t (e.g., an output of the software program in question). Also, given the multipliers for each neuron to its immediate successors, at least one embodiment can include computing the multipliers for any neuron to a given target neuron efficiently via backpropagation. In such an embodiment, such a process is also referred to as the chain rule for multipliers.

The implementation of at least portions of one or more embodiments can be achieved, for example, as depicted in FIG. 10 through FIG. 12, by using Keras with a Tensorflow backend, Python language, and one or more ScikitLearn libraries.

FIG. 10 shows example pseudocode for determining system behavior associated with a given item of software in an illustrative embodiment. In this embodiment, example pseudocode 1000 is executed by or under the control of at least one processing system and/or device. For example, the example pseudocode 1000 may be viewed as comprising a portion of a software implementation of at least part of automated software reverse engineering system 105 of the FIG. 1 embodiment.

The example pseudocode 1000 illustrates code for determining system behavior associated with a given item of software, wherein the example pseudocode 1200 can use a range of input values (e.g., input values ranging from −4 to 20). While running the given software, example pseudocode 1000 captures the input-output values of the given software into input.txt and output.txt files.

It is to be appreciated that this particular example pseudocode shows just one example implementation of determining system behavior associated with a given item of software, and alternative implementations can be used in other embodiments.

FIG. 11 shows example pseudocode for implementing at least a portion of a multimodal artificial intelligence-based prediction engine in an illustrative embodiment. In this embodiment, example pseudocode 1100 is executed by or under the control of at least one processing system and/or device. For example, the example pseudocode 1100 may be viewed as comprising a portion of a software implementation of at least part of automated software reverse engineering system 105 of the FIG. 1 embodiment.

The example pseudocode 1100 illustrates obtaining input and output values of a software program from at least one tracing system. Additionally, example pseudocode 1100 illustrates choosing an appropriate model (e.g., a decision tree classifier model, a neural network model, etc.) for the obtained tracing system data, and fitting the model to at least a portion of the obtained tracing system data. Further, example pseudocode 1100 depicts using an explainable source (e.g., using decision tree classifier model rules) for extracting model information in a human-readable format. More particularly, in at least one embodiment, the model is read using the explainable artificial intelligence to derive logic and/or functionality in the code.

It is to be appreciated that this particular example pseudocode shows just one example implementation of at least a portion of a multimodal artificial intelligence-based prediction engine, and alternative implementations can be used in other embodiments.

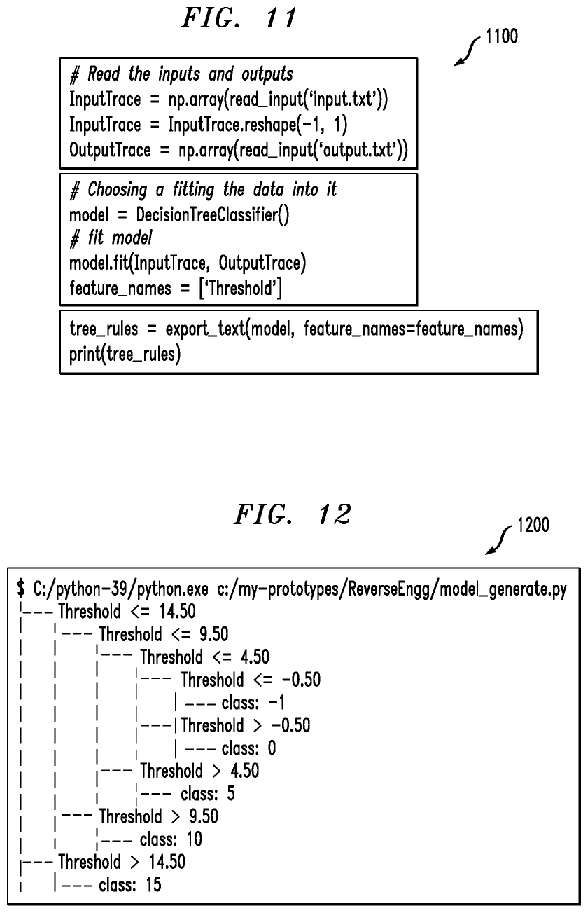

FIG. 12 shows example pseudocode for generating at least a portion of a software reverse engineering output in an illustrative embodiment. In this embodiment, example pseudocode 1200 is executed by or under the control of at least one processing system and/or device. For example, the example pseudocode 1200 may be viewed as comprising a portion of a software implementation of at least part of automated software reverse engineering system 105 of the FIG. 1 embodiment.

The example pseudocode 1200 illustrates an output, generated using artificial intelligence techniques, representing an approximation of the original code of the given software program in question. For example, such an output as illustrated in example pseudocode 1200 provides insights into the underlying logic and one or more thresholds associated with the given software program in question.

It is to be appreciated that this particular example pseudocode shows just one example implementation of generating at least a portion of a software reverse engineering output, and alternative implementations can be used in other embodiments.

Accordingly, and as detailed herein, one or more embodiments include determining and/or understanding a given software program's business logic and/or knowledge by learning the given software program's input-output values and/or logs and interpreting the acquired knowledge. More particularly, at least one embodiment includes leveraging the use of artificial intelligence techniques to learn input and output values for the given software program, and interpreting such learned values to reverse engineer at least a portion of the given software program.

Such an embodiment includes automatically assessing correlations in collected transactional data from the given software program and predicting the behavior of the given software program, rather than directly examining the source code of the given software application. A source of data for model creation, in one or more embodiments, is transactional data captured during monitoring of the given software program, with a goal of recreating the given software program's behavior. Accordingly, an objective of such an embodiment includes utilizing software program monitoring data to create at least one model that can mimic the given software program (e.g., retracing the output(s) of the given software program).

As detailed herein, one or more embodiments are compatible with software programs written in any programming language and/or platform. Additionally, as such an embodiment includes context-aware techniques, such an embodiment can include interpreting predictions in one or more manners that human users can process and/or comprehend. Thus, a user with limited programming language knowledge can, in connection with one or more embodiments, comprehend the given software program's functionality and use case context. Further, by implementing the reverse engineering techniques detailed herein across various systems and/or software programs, at least one embodiment can include creating and/or maintaining one or more knowledge bases pertaining to software engineering.

By way merely of illustration, consider the following example use case, wherein a legacy software program has been running for a few years. Recently, it was determined that the legacy software program is not meeting one or more new service level agreements (SLAs), and as such, there is a desire to understand what the legacy software program and/or related API is doing and if there is any suitable software program that can replace the legacy software program. However, in this example, the legacy software program is a core service for the given enterprise, and the given enterprise is apprehensive that any modification made to the legacy software program might have adverse effects. Also, the subject matter experts who previously worked on the legacy software program have left the given enterprise, and limited knowledge is available about the legacy software program's internals.

Additionally, in such an example use case, at least one monitoring system can run on top of the legacy software program, capturing data pertaining to the transactions that the legacy software program carries out. Under such circumstances, at least one embodiment includes processing at least a portion of such data (e.g., traces and/or related information captured by the at least one monitoring system) using at least one multimodal artificial intelligence-based prediction engine. Such an embodiment can also include building and/or training at least one artificial intelligence model that mirrors the legacy software program and predicts one or more outputs of the legacy software program. Further, such an embodiment can additionally include implementing at least one prediction interpretation engine on top of the at least one multimodal artificial intelligence-based prediction engine to extricate information on why one or more given predicted outputs were generated for at least one given input, and reverse engineering at least a portion of the legacy software program based at least in part on the extricated information. Accordingly, such an embodiment includes deriving engineering insights into the legacy software program without having to investigate the source code of the legacy software program.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based on input data, output data, and/or sequence data collected from various software programs, and such recommendations and/or predictions can be used to initiate one or more automated actions (e.g., automatically reverse engineering at least a portion of a given software program, automatically retraining one or more artificial intelligence techniques, etc.).

FIG. 13 is a flow diagram of a process for context-based software engineering using artificial intelligence techniques in an illustrative embodiment. It is to be understood that this particular process is only an example, and additional or alternative processes can be carried out in other embodiments.

In this embodiment, the process includes steps 1300 through 1306. These steps are assumed to be performed by automated software reverse engineering system 105 utilizing elements 112, 114, 116 and 118.

Step 1300 includes obtaining input data associated with at least one software program. In at least one embodiment, obtaining input data includes obtaining time series data from one or more automated software monitoring logs. Additionally or alternatively, obtaining input data can include obtaining JSON values associated with the at least one software program.

Step 1302 includes predicting one or more outputs which can be generated by the at least one software program, in response to at least a portion of the input data, by processing the input data using one or more artificial intelligence techniques. In one or more embodiments, predicting one or more outputs includes processing the input data using at least one MIMO neural network. In such an embodiment, processing the input data using at least one MIMO neural network can include using at least one MIMO neural network in conjunction with one or more deep learning important features techniques to compute at least one importance score for at least one of the one or more predicted outputs based at least in part on a difference between the at least one of the one or more predicted outputs and at least one reference output in relation to a difference between the at least a portion of the input data and at least one corresponding reference input.

Step 1304 includes generating one or more items of supporting information attributed to at least a portion of the one or more predicted outputs. In at least one embodiment, generating one or more items of supporting information includes perturbing one or more data points from the at least a portion of the input data and generating one or more corresponding synthetic data points to be utilized in training at least one glass box model.

Step 1306 includes automatically reverse engineering at least a portion of the at least one software program using at least one of the one or more predicted outputs and the one or more items of supporting information. In one or more embodiments, automatically reverse engineering at least a portion of the at least one software program includes generating, using at least a portion of the one or more predicted outputs and at least a portion of the one or more items of supporting information, at least one artificial intelligence model that mimics at least a portion of the at least one software program.

The techniques depicted in FIG. 13 can also include training at least a portion of the one or more artificial intelligence techniques using one or more of historical input data associated with the at least one software program, historical output data associated with the at least one software program, and historical database operations data associated with the at least one software program. Additionally or alternatively, one or more embodiments can include automatically retraining at least a portion of the one or more artificial intelligence techniques based on feedback related to at least one of the one or more predicted outputs.

Accordingly, the particular processing operations and other functionality described in conjunction with the flow diagram of FIG. 13 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically reverse engineer at least a portion of a given software program, without needing to examine the source code of the given software program, using one or more artificial intelligence techniques. These and other embodiments can effectively overcome problems associated with time-consuming, resource-intensive, and platform and/or programming language dependent techniques. It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

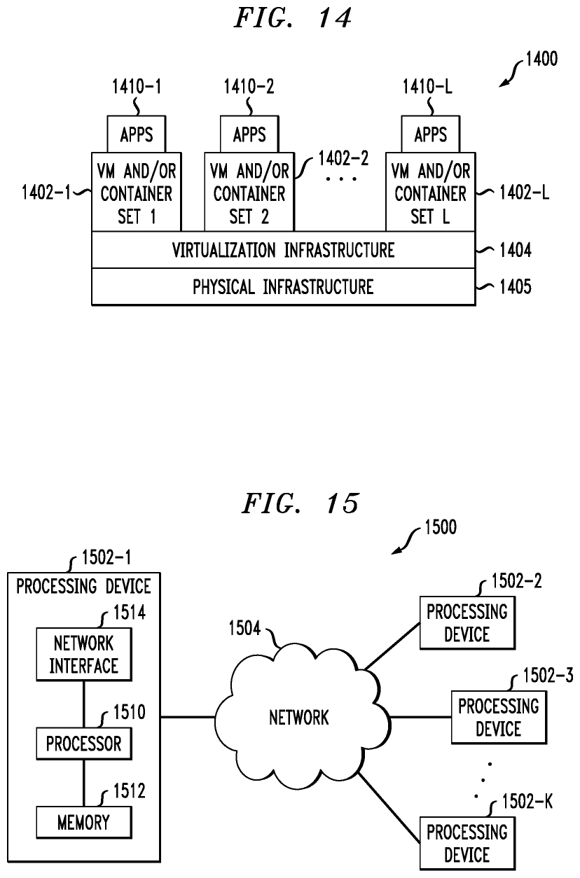

Illustrative embodiments of processing platforms will now be described in greater detail with reference to FIGS. 14 and 15. Although described in the context of system 100, these platforms may also be used to implement at least portions of other information processing systems in other embodiments.

FIG. 14 shows an example processing platform comprising cloud infrastructure 1400. The cloud infrastructure 1400 comprises a combination of physical and virtual processing resources that are utilized to implement at least a portion of the information processing system 100. The cloud infrastructure 1400 comprises multiple virtual machines (VMs) and/or container sets 1402-1, 1402-2, . . . 1402-L implemented using virtualization infrastructure 1404. The virtualization infrastructure 1404 runs on physical infrastructure 1405, and illustratively comprises one or more hypervisors and/or operating system level virtualization infrastructure. The operating system level virtualization infrastructure illustratively comprises kernel control groups of a Linux operating system or other type of operating system.

The cloud infrastructure 1400 further comprises sets of applications 1410-1, 1410-2, . . . 1410-L running on respective ones of the VMs/container sets 1402-1, 1402-2, . . . 1402-L under the control of the virtualization infrastructure 1404. The VMs/container sets 1402 comprise respective VMs, respective sets of one or more containers, or respective sets of one or more containers running in VMs. In some implementations of the FIG. 14 embodiment, the VMs/container sets 1402 comprise respective VMs implemented using virtualization infrastructure 1404 that comprises at least one hypervisor.

A hypervisor platform may be used to implement a hypervisor within the virtualization infrastructure 1404, wherein the hypervisor platform has an associated virtual infrastructure management system. The underlying physical machines comprise one or more information processing platforms that include one or more storage systems.

In other implementations of the FIG. 14 embodiment, the VMs/container sets 1402 comprise respective containers implemented using virtualization infrastructure 1404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1400 shown in FIG. 14 may represent at least a portion of one processing platform. Another example of such a processing platform is processing platform 1500 shown in FIG. 15.

The processing platform 1500 in this embodiment comprises a portion of system 100 and includes a plurality of processing devices, denoted 1502-1, 1502-2, 1502-3, . . . 1502-K, which communicate with one another over a network 1504.

The network 1504 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1502-1 in the processing platform 1500 comprises a processor 1510 coupled to a memory 1512.

The processor 1510 comprises a microprocessor, a CPU, a GPU, a TPU, a microcontroller, an ASIC, a FPGA or other type of processing circuitry, as well as portions or combinations of such circuitry elements.

The memory 1512 comprises random access memory (RAM), read-only memory (ROM) or other types of memory, in any combination. The memory 1512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1502-1 is network interface circuitry 1514, which is used to interface the processing device with the network 1504 and other system components, and may comprise conventional transceivers.

The other processing devices 1502 of the processing platform 1500 are assumed to be configured in a manner similar to that shown for processing device 1502-1 in the figure.

Again, the particular processing platform 1500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining input data associated with at least one software program;
predicting one or more outputs which can be generated by the at least one software program, in response to at least a portion of the input data, by processing the input data using one or more artificial intelligence techniques;
generating one or more items of supporting information attributed to at least a portion of the one or more predicted outputs; and
automatically reverse engineering at least a portion of the at least one software program using at least one of the one or more predicted outputs and the one or more items of supporting information;
wherein the method is performed by at least one processing device comprising a processor coupled to a memory.

2. The computer-implemented method of claim 1, wherein predicting one or more outputs comprises processing the input data using at least one multi-input multi-output (MIMO) neural network.

3. The computer-implemented method of claim 2, wherein processing the input data using at least one MIMO neural network comprises using at least one MIMO neural network in conjunction with one or more deep learning important features techniques to compute at least one importance score for at least one of the one or more predicted outputs based at least in part on a difference between the at least one of the one or more predicted outputs and at least one reference output in relation to a difference between the at least a portion of the input data and at least one corresponding reference input.

4. The computer-implemented method of claim 1, wherein automatically reverse engineering at least a portion of the at least one software program comprises generating, using at least a portion of the one or more predicted outputs and at least a portion of the one or more items of supporting information, at least one artificial intelligence model that mimics at least a portion of the at least one software program.

5. The computer-implemented method of claim 1, wherein generating one or more items of supporting information comprises perturbing one or more data points from the at least a portion of the input data and generating one or more corresponding synthetic data points to be utilized in training at least one glass box model.

6. The computer-implemented method of claim 1, wherein obtaining input data comprises obtaining time series data from one or more automated software monitoring logs.

7. The computer-implemented method of claim 1, wherein obtaining input data comprises obtaining JavaScript object notation (JSON) values associated with the at least one software program.

8. The computer-implemented method of claim 1, further comprising:
training at least a portion of the one or more artificial intelligence techniques using one or more of historical input data associated with the at least one software program, historical output data associated with the at least one software program, and historical database operations data associated with the at least one software program.

9. The computer-implemented method of claim 1, further comprising:
automatically retraining at least a portion of the one or more artificial intelligence techniques based on feedback related to at least one of the one or more predicted outputs.

10. A non-transitory processor-readable storage medium having stored therein program code of one or more software programs, wherein the program code when executed by at least one processing device causes the at least one processing device:
to obtain input data associated with at least one software program;
to predict one or more outputs which can be generated by the at least one software program, in response to at least a portion of the input data, by processing the input data using one or more artificial intelligence techniques;
to generate one or more items of supporting information attributed to at least a portion of the one or more predicted outputs; and
to automatically reverse engineer at least a portion of the at least one software program using at least one of the one or more predicted outputs and the one or more items of supporting information.

11. The non-transitory processor-readable storage medium of claim 10, wherein predicting one or more outputs comprises processing the input data using at least one MIMO neural network.

12. The non-transitory processor-readable storage medium of claim 11, wherein processing the input data using at least one MIMO neural network comprises using at least one MIMO neural network in conjunction with one or more deep learning important features techniques to compute at least one importance score for at least one of the one or more predicted outputs based at least in part on a difference between the at least one of the one or more predicted outputs and at least one reference output in relation to a difference between the at least a portion of the input data and at least one corresponding reference input.

13. The non-transitory processor-readable storage medium of claim 10, wherein automatically reverse engineering at least a portion of the at least one software program comprises generating, using at least a portion of the one or more predicted outputs and at least a portion of the one or more items of supporting information, at least one artificial intelligence model that mimics at least a portion of the at least one software program.

14. The non-transitory processor-readable storage medium of claim 10, wherein generating one or more items of supporting information comprises perturbing one or more data points from the at least a portion of the input data and generating one or more corresponding synthetic data points to be utilized in training at least one glass box model.

15. The non-transitory processor-readable storage medium of claim 10, wherein obtaining input data comprises obtaining time series data from one or more automated software monitoring logs.

16. An apparatus comprising:
at least one processing device comprising a processor coupled to a memory;
the at least one processing device being configured:
to obtain input data associated with at least one software program;
to predict one or more outputs which can be generated by the at least one software program, in response to at least a portion of the input data, by processing the input data using one or more artificial intelligence techniques;
to generate one or more items of supporting information attributed to at least a portion of the one or more predicted outputs; and
to automatically reverse engineer at least a portion of the at least one software program using at least one of the one or more predicted outputs and the one or more items of supporting information.

17. The apparatus of claim 16, wherein predicting one or more outputs comprises processing the input data using at least one MIMO neural network.

18. The apparatus of claim 17, wherein processing the input data using at least one MIMO neural network comprises using at least one MIMO neural network in conjunction with one or more deep learning important features techniques to compute at least one importance score for at least one of the one or more predicted outputs based at least in part on a difference between the at least one of the one or more predicted outputs and at least one reference output in relation to a difference between the at least a portion of the input data and at least one corresponding reference input.

19. The apparatus of claim 16, wherein automatically reverse engineering at least a portion of the at least one software program comprises generating, using at least a portion of the one or more predicted outputs and at least a portion of the one or more items of supporting information, at least one artificial intelligence model that mimics at least a portion of the at least one software program.

20. The apparatus of claim 16, wherein generating one or more items of supporting information comprises perturbing one or more data points from the at least a portion of the input data and generating one or more corresponding synthetic data points to be utilized in training at least one glass box model.
